(19) United States
(12) Patent Application Publication
(10) Pub. No.: US 2012/0290711 A1
(43) Pub. Date: Nov. 15, 2012

(54) METHOD AND APPARATUS TO ESTIMATE APPLICATION AND NETWORK PERFORMANCE METRICS AND DISTRIBUTE THOSE METRICS ACROSS THE APPROPRIATE APPLICATIONS, SITES, SERVERS, ETC

(75) Inventors: Michael Upham, Colorado Springs, CO (US); John Monk, Larkspur, CO (US); Dan Prescott, Elbert, CO (US); Robert Vogt, Colorado Springs, CO (US)

(73) Assignee: FLUKE CORPORATION, Everett, WA (US)

(21) Appl. No.: 13/106,838

(22) Filed: May 12, 2011

(51) Int. Cl. G06F 15/173

(52) U.S. Cl. 709/224

(57) ABSTRACT

A method and apparatus to estimate application and network performance metrics and distribute those metrics across the appropriate applications, sites, servers, and the like, performs shallow analysis on a majority of traffic and deep analysis on a sampled set of the traffic, and estimates network and application performance metrics for the non-deep analysis data, providing an overall estimate of metrics without requiring deep analysis of all traffic.

### BACKGROUND OF THE INVENTION

This invention relates to networking, and more particularly to network monitoring employing estimates of network performance metrics.

Complete network and application performance analysis on all traffic in high volume/high speed networks may be impractical in real time. Providing the computational resources and/or analysis bandwidth needed to fully analyze all traffic may be unfeasible or too costly. However, meaningful analysis is a critical component of maintaining and troubleshooting such high speed and high volume networks.

### SUMMARY OF THE INVENTION

An object of the invention is to provide for method and apparatus to estimate application and network performance metrics and distribute those metrics to provide accurate estimates for traffic when complete analysis is not available in real time.

Accordingly, it is another object of the present invention to provide an improved network monitoring system, method and apparatus that estimates application performance metrics and distributes those metrics to appropriate systems.

It is yet a further object of the present invention to provide a system, method and apparatus that performs dual-depth analysis of IP network traffic with deeper analysis on some traffic and shallower analysis on other traffic and uses that analysis to estimate results if deep analysis had been performed on both sets of traffic.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a network with a network analysis product interfaced therewith;

FIG. 2 is a block diagram of a monitor device for estimating application and network performance metrics;

FIG. 3 is a high level diagram of the dual-depth analysis; and

FIG. 4 is a diagram illustrating the operation of the apparatus and method to estimate application and network performance metrics and distribute those metrics.

### DETAILED DESCRIPTION

The system according to a preferred embodiment of the present invention comprises a monitoring system and method and an analysis system and method for estimating application and network performance metrics and distributing those metrics across the appropriate applications, sites, servers, etc.

Shallow analysis is performed on all of a set of traffic with deep analysis being performed on a sampled subset of the shallow analyzed traffic, and the resulting dual-depth analysis results are used to estimate distribution on all of the set of traffic, without requiring deep analysis on the entire set.

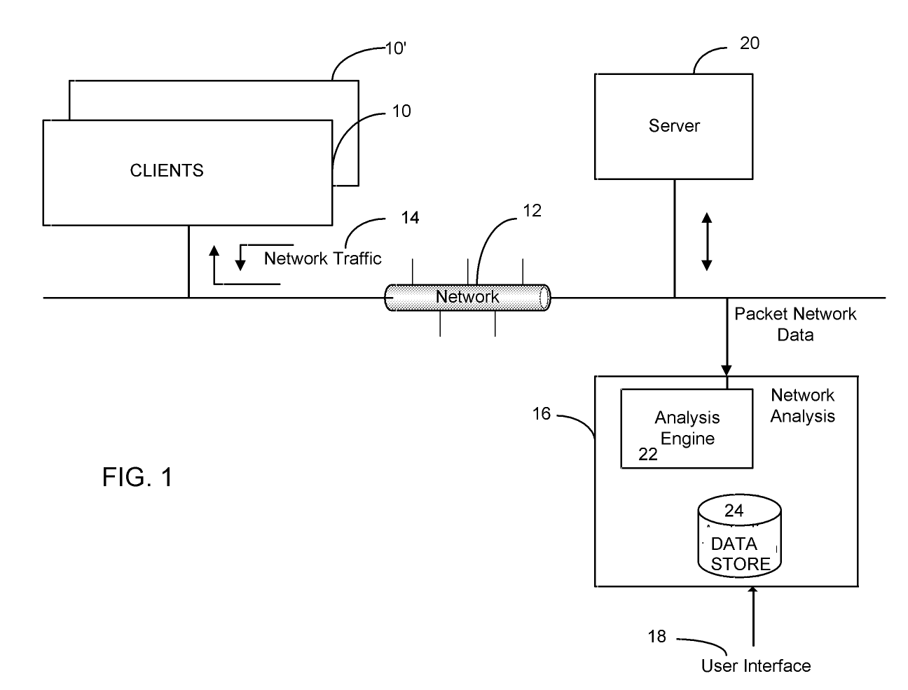

Referring to FIG. 1, a block diagram of a network with an apparatus in accordance with the disclosure herein, a network may comprise plural network clients 10, 10′, etc., which communicate over a network 12 by sending and receiving network traffic 14 via interaction with server 20. The traffic may be sent in packet form, with varying protocols and formatting thereof.

A network analysis device 16 is also connected to the network, and may include a user interface 18 that enables a user to interact with the network analysis device to operate the analysis device and obtain data therefrom, whether at the location of installation or remotely from the physical location of the analysis product network attachment.

The network analysis device comprises hardware and software, CPU, memory, interfaces and the like to operate to connect to and monitor traffic on the network, as well as performing various testing and measurement operations, transmitting and receiving data and the like. When remote, the network analysis device typically is operated by running on a computer or workstation interfaced with the network. One or more monitoring devices may be operating at various locations on the network, providing measurement data at the various locations, which may be forwarded and/or stored for analysis.

The analysis device comprises an analysis engine 22 which receives the packet network data and interfaces with data store 24.

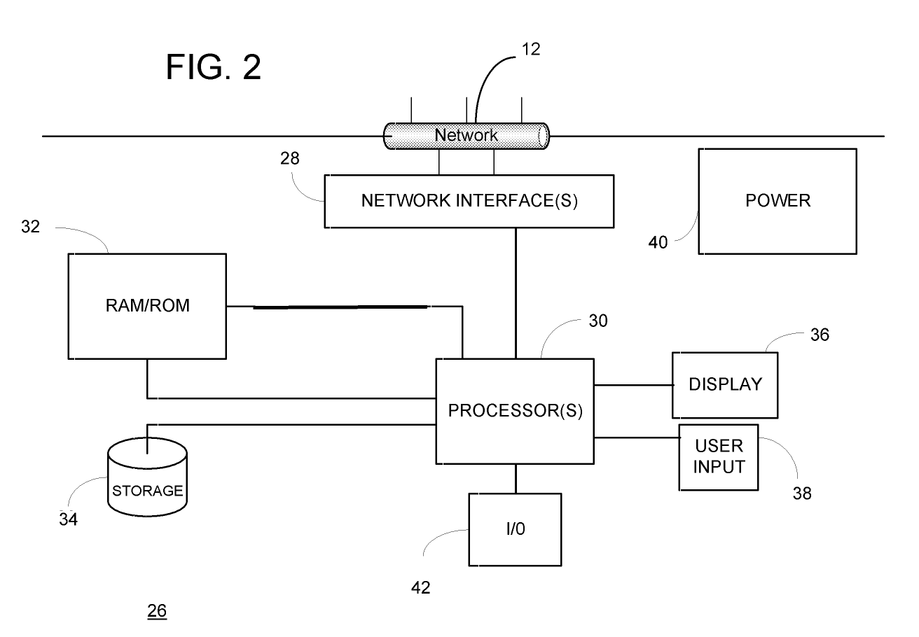

FIG. 2 is a block diagram of a test instrument/analyzer 26 via which the invention can be implemented, wherein the instrument may include network interfaces 28 which attach the device to a network 12 via multiple ports, one or more processors 30 for operating the instrument, memory such as RAM/ROM 32 or persistent storage 34, display 36, user input devices (such as, for example, keyboard, mouse or other pointing devices, touch screen, etc.), power supply 40 which may include battery or AC power supplies, other interface 42 which attaches the device to a network or other external devices (storage, other computer, etc.).

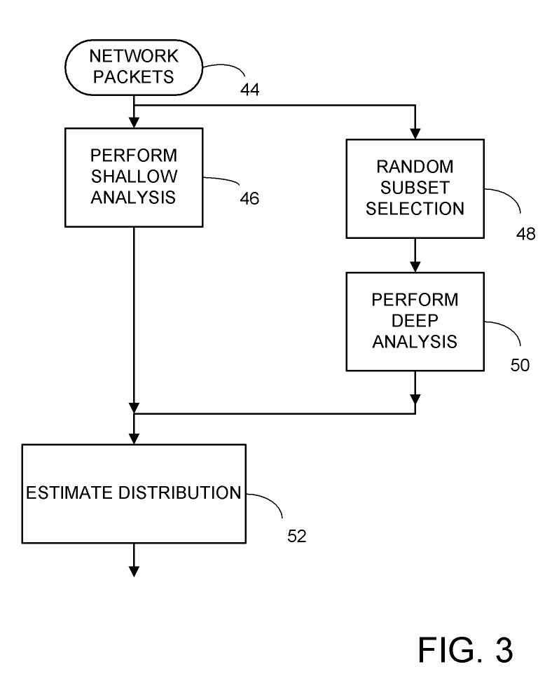

In operation, with reference to FIG. 3, a high level diagram of the dual-depth analysis, the network test instrument is attached to the network, and observes transmissions 44 on the network to collect data and analyze and produce statistics thereon. The test instrument is able to estimate application and network performance metrics and distribute those metrics across the appropriate applications, sites, servers, etc., when deep analysis on all the traffic flows is not practicable in real time.

In a particular application, for example where it is not possible to provide deep analysis 50 (OSI model layers transport-4 through application-7) analysis in real time, deep analysis 50 is be done on a sampling 48 of flows, with shallow, analysis 46 (OSI model layers physical-1 through transport-4) performed on all other flows in order to provide a baseline for estimating at 52 the application and network performance metrics for each application, server, site, client, etc. which would have been seen if deep analysis been performed in real time on all flows.

In operation of the apparatus and method to estimate application and network performance metrics and distribute those metrics, for each observed packet, a shallow analysis is performed to determine network addressing (IPv4/IPv6/etc.), transport type and attributes (TCP Port/UDP Port/etc.), and traffic flow directionality (client/server distinction). This information is used to categorize the traffic packets and flows into applications, protocols, servers, sites, clients, etc. The most specific definition is chosen whenever there are overlaps. An application is a network application defined by a transport protocol type (e.g. TCP or UDP) and a standard set of ports or port ranges the application will operate on. For example, a simple application definition for “HTTP” could be TCP ports 80, 8000, 8008, and/or 8080. Applications can also be much more complex in that they can be defined by an optional set of network layer (IP Address), an optional set of transport layer according to the transport protocol type (TCP/UDP/etc.), and/or an optional set of higher layer (OSI model layers 5-7) attributes. The application can further be defined in terms of a simple or complex protocol whereby the protocol defines the context in terms of the network or transport layer attributes which make up the protocol classification. For example, a complex application named “MyWebApp” could be defined as TCP port 80, 8080-8089 on server IP addresses 172.16.12.16-172.16.12.17 and 172.16.12.20 and with a partial URI of “/myweb”. It is important to note that each attribute above is optional and there are many variations on application definitions; the application definition itself noted herein is not a limitation to the scope of the claims but is provided in order to help appreciate what is being claimed.

The packet counts for each unique application, protocol, server, site, client, etc. are summed up over an aggregation interval, and each set of aggregated packet counts is cached for a configurable number of intervals (last N).

A deep analysis is performed on a random subset of packet flows, allowing further categorization of the flows performed in the shallow analysis. A sampled packet flow is checked to see if it matches a complex application definition. The complex application definition extends the simple application definition to include higher layer (OSI model layers 5-7) attributes which can only be identified via deep, application/protocol-specific analysis of the packet flow. These higher layer attributes might be, for example, a list of full or partial URLs for HTTP, a set of specific database names for Oracle, a published application for Citrix-INA, etc. For example, a complex application named “StoreWebTraffic” could be defined as TCP port 80 on server IP address 172.16.12.16, but only with URLs containing the strings “/retail” or “/sales”.

If a sampled packet flow is found to match a complex application definition, its application categorization is changed to the more specific complex application definition, and a new network and application performance metric aggregation is performed for the new categorization. Again, aggregated metrics are cached for a configurable number of intervals.

Since traffic categorized by Shallow Analysis but not included in Deep Analysis may be insufficiently categorized because the higher layer (OSI model layers 5-7) analysis was not done, a better distribution for such traffic is estimated.

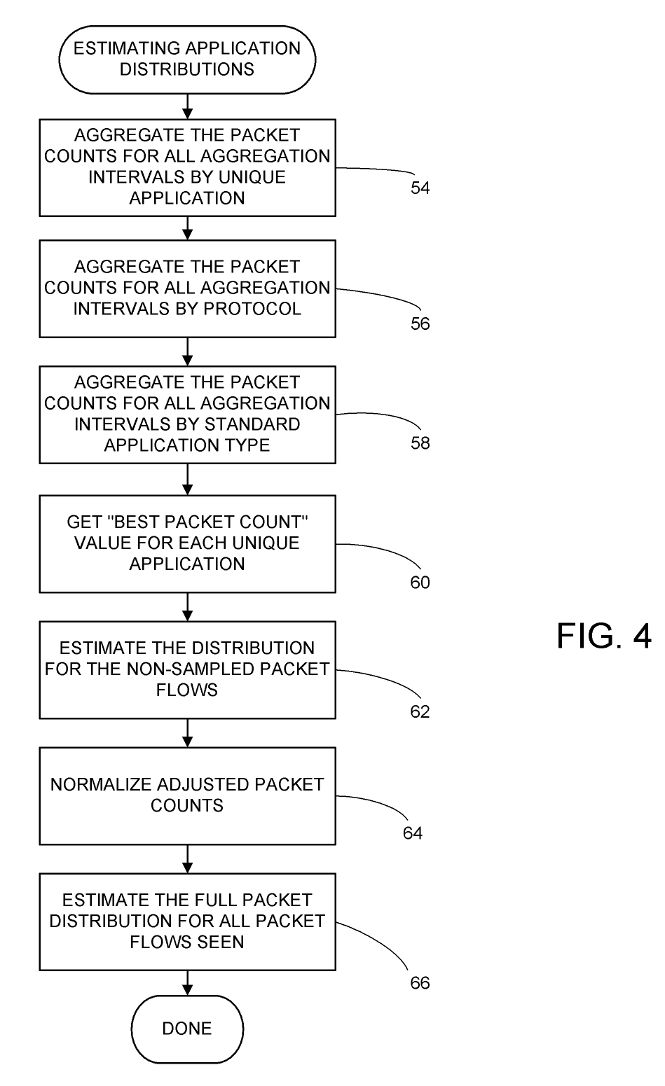

The estimation is determined, with reference to FIG. 4, a flow chart of the operation, as follows:

Aggregate the packet counts for all aggregation intervals by unique application (block 54). This aggregation is accomplished by summing up the packet count aggregations for all of the deep analysis packet flows over the last N aggregation intervals, grouped by application.

Aggregate the packet counts for all aggregation intervals by protocol (block 56). Some custom applications will share the same underlying protocol (transport type and port range list) with others. A sum of the deep analysis packet aggregations over the last N aggregation intervals, grouped by protocol, is determined.

Next, in block 58, an aggregate of the packet counts for all aggregation intervals by standard application type is determined. Many applications will share an underlying standard application type due to the flexibility of the application definitions (e.g. “MyWebTraffic” and “StoreWebTraffic” might both be of application type HTTP). Here we sum up the deep analysis packet aggregations over the last N aggregation intervals, grouped by application type (HTTP, MySQL, MS-SQL, Oracle, Citrix, CIFS, etc).

In block 60, a “Best Packet Count” value for each unique application is obtained. Steps 54-58 generate three Deep Analysis packet count aggregation sets which can be used to estimate application distributions, from most specific (by specific application) to least specific (by application type). Here, we use the most specific non-zero value from the aggregation set that applies to a specific application. For example, if the application-specific packet count for “StoreWebTraffic” is 0, then the protocol-specific packet count for that application is used. If the protocol-specific packet count is also 0, then look up the application-type packet count for that application. If all three are zero, the “Best Packet Count” is 0.

Now, at block 62, we estimate the distribution for the non-sampled packet flows. For each application seen in the aggregation of sampled packet flows seen in step 54, multiply the packet count of the current aggregation interval by the ratio of “Best Packet Count” in Step 60 to the total number of Deep Analysis packets seen during the last N aggregation intervals:

AdjustedPacketCountₐₚₚ=NonSampledPacketCountₐₚₚ*BestPacketCount_{BestType}/TotalPacketCount_{BestType}

This will redistribute the non-sampled packet counts to be in line with recent sampled packet count distributions across all applications.

Next, at block 64, the adjusted packet counts are normalized. Step 62 relies on multiple aggregation methods to find a “Best Packet Count” for each application, and the adjustment ratios may vary somewhat, potentially causing the total adjusted packet count to be larger or smaller than the actual number of non-sampled packet count seen on the wire. Accordingly, normalization of the adjusted packet counts from the previous step is accomplished by multiplying each of the adjusted packet counts by the ratio of the sum of the total non-sampled packet counts seen on the network to the sum of the adjusted packet counts:

NormalizedPacketCountₐₚₚ=AdjustedPacketCountₐₚₚ*ΣPacketCountₐₚₚ /ΣAdjustedPacketCountₐₚₚ

Now, in step 66, an estimate is determined of the full packet distribution for all packet flows seen on the network. This is accomplished by adding the Normalized Packet Count for each non-sampled application in the current interval to the packet counts for sampled packet flows determined during Deep analysis to arrive at a full estimation of the application distribution in the current interval.

The percentage of packets randomly sampled for which deep analysis is made can be varied from very low to very high. Percentages as low as 10% or 5% or less can provide sufficient data for accurate estimates. The percentage can be varied to higher values, 60% or greater, as desired, based on network specifics, traffic volume and type and processing and analysis bandwidth availability.

The particular implementation discussed herein relates to the packet count metric, but the process can be applied in other specific ways and to other network and application performance metrics to provide analysis of lesser detail or computational intensity of most data and more detailed analysis of a sampling of a given data set, and estimation of the likely results had detailed analysis been applied to the data analyzed in lesser detail.

Accordingly, the invention provides a system, method and apparatus for network monitoring to estimate application and network performance metrics based on detailed analysis of a random subset of network traffic, and to distribute those metrics across the appropriate applications, sites, servers and the like.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method of monitoring network traffic, comprising:
performing shallow analysis for a set of network traffic;
performing deep analysis on a sampled subset of the set of traffic receiving shallow analysis; and
estimating network traffic deep analysis results for traffic from the traffic set receiving only shallow analysis based on results of performing deep analysis on the sampled subset of the traffic.

2. The method according to claim 1, wherein said shallow analysis comprises determining packet counts and other network and application performance metrics over an aggregation interval.

3. The method according to claim 2, wherein said estimating network deep analysis results comprises:
aggregating packet counts and other network and application performance metrics for all aggregation intervals by unique application;
aggregating packet counts and other network and application performance metrics for all aggregation intervals by protocol;
determining a best packet count value for unique applications;
estimating packet counts and other network and application performance metrics for non-sampled packet flows;
normalizing the estimated packet counts and other network and application performance metrics for non-sampled packet flows; and
adding the normalized estimated packet counts and other network and application performance metrics for non-sampled flows to the packet counts and other network and application performance metrics for sampled packet flows to provide a full estimation.

4. A network test instrument for monitoring network traffic and estimating application and network performance metrics, comprising:
network data acquisition device for observing the network traffic;
said network data acquisition device including a processor, said processor:
performing shallow analysis for a majority of a set of observed network traffic;
performing deep analysis on a sampled subset of the majority of the set of observed traffic having received shallow analysis; and
estimating network traffic deep analysis results for traffic from the traffic receiving only shallow analysis based on results of performing deep analysis on the sampled subset of the traffic.

5. The network test instrument according to claim 4, wherein said shallow analysis comprises determining packet counts and other network and application performance metrics over an aggregation interval.

6. The network test instrument according to claim 5, wherein said estimating network deep analysis results comprises:
aggregating packet counts and other network and application performance metrics for all aggregation intervals by unique application;
aggregating packet counts and other network and application performance metrics for all aggregation intervals by protocol;
determining a best packet count value for unique applications;
estimating packet counts and other network and application performance metrics for non-sampled packet flows;
normalizing the estimated packet counts and other network and application performance metrics for non-sampled packet flows; and
adding the normalized estimated packet counts and other network and application performance metrics for non-sampled flows to the packet counts and other network and application performance metrics for sampled packet flows to provide a full estimation.

7. A system for monitoring network traffic comprising:
a network monitoring system for observing network traffic;
a first analyzer for performing a first analysis type on a set of observed network traffic;
a second analyzer for performing a second analysis type on a sampled subset of observed network traffic;
an estimator for estimating network traffic analysis as provided by said second analysis type for the traffic receiving only the first analysis type, said estimator determining said estimated network traffic analysis based on the first and second analysis.

8. The system according to claim 7, wherein said first analysis type comprises a shallow analysis and said second analysis type comprises a deep analysis.

9. The system according to claim 8, wherein said shallow analysis comprises determining packet counts and other network and application performance metrics over an aggregation interval.

10. The system according to claim 9, wherein said estimator:
aggregates packet counts and other network and application performance metrics for all aggregation intervals by unique application;
aggregates packet counts and other network and application performance metrics for all aggregation intervals by protocol;
determines a best packet count value for unique applications;
estimates packet counts and other network and application performance metrics for non-sampled packet flows;
normalizes the estimated packet counts and other network and application performance metrics for non-sampled packet flows; and
adds the normalized estimated packet counts and other network and application performance metrics for non-sampled flows to the packet counts and other network and application performance metrics for sampled packet flows to provide a full estimation.
